(19) United States
(12) Patent Application Publication
(10) Pub. No.: US 2015/0192670 A1
(43) Pub. Date: Jul. 9, 2015

(54) METHOD AND APPARATUS FOR EXTRACTING IONOSPHERIC TRACE

(71) Applicant: Electronics and Telecommunications Research Institute, Daejeon (KR)

(72) Inventors: Jin Ho JO, Daejeon (KR); Moonhee YOU, Daejeon (KR); Cheol Oh JEONG, Daejeon (KR); Yong-Min LEE, Daejeon (KR); Hwan Sang LEE, Jeju-si Jeju-do (KR)

(21) Appl. No.: 14/309,378

(22) Filed: Jun. 19, 2014

(30) Foreign Application Priority Data
Jan. 8, 2014 (KR) 10-2014-0002557

(51) Int. Cl. G01S 13/95; G06K 9/62

(52) U.S. Cl. CPC G01S 13/95; G06K 9/624

(57) ABSTRACT

A method and apparatus for extracting an ionospheric trace are provided. The trace extraction method includes: searching for a signal data having maximum strength among signal data displayed on an ionogram of the ionosphere; selecting the point where the signal data having maximum strength is placed as a first point; extracting the trace on the right side of the first point while increasing frequency of the signal data; and extracting the trace on the left side of the first point while decreasing the frequency.

### CROSS-REFERENCE TO RELATED APPLICATION

This application claims priority to and the benefit of Korean Patent Application No. 10-2014-0002557 filed in the Korean Intellectual Property Office on Jan. 8, 2014, the entire contents of which are incorporated herein by reference.

### BACKGROUND OF THE INVENTION

(a) Field of the Invention

The present invention relates to a method and apparatus for extracting an ionospheric trace by analyzing an ionosphere observation signal by radar.

(b) Description of the Related Art

The ionosphere is an ionic layer which exists at an altitude of between 60 and 800 km, and affects radio communications on the ground and communications with satellites. Accordingly, ionospheric observations are constantly being made. In this case, the technique for analyzing an ionosphere observation signal is as important as the ionosphere observation technique.

Typically, the altitude and variation of the ionosphere can be observed by sending a radar signal into the sky using radar with a high-frequency (HF) band and receiving and analyzing the radar signal (ionosphere observation signal) reflected from the ionosphere. One of the most accurate techniques developed for more precise analysis of an ionosphere observation signal is a technique for accurate extraction of the reflecting plane from the ionosphere observation signal.

With the conventional trace extraction technology, it was not possible to accurately extract the trace if the altitude of the ionosphere changes abruptly at a particular frequency as a point of discontinuity occurs at the ionosphere, or if the ionosphere is formed discontinuously at some frequency because no reflection signal exists at a particular frequency.

### SUMMARY OF THE INVENTION

The present invention has been made in an effort to provide a method and apparatus for extracting an ionospheric trace, by which the ionospheric trace can be extracted accurately even when a point of discontinuity occurs at the ionosphere.

An exemplary embodiment of the present invention provides a method for extracting an ionospheric trace. The trace extraction method includes: searching for a signal data having maximum strength among signal data displayed on an ionogram of the ionosphere; selecting the point where a signal data having maximum strength is placed as a first point; extracting a trace on the right side of the first point while increasing frequency of the signal data; and extracting the trace on the left side of the first point while decreasing the frequency.

In the trace extraction method, the extracting of the trace on the right side may include: choosing a plurality of first representative directions on the right side; calculating a sum of strengths of n signal data closest to the first point among the signal data existing in the first representative directions; and extracting the trace based on the sum of the strengths.

In the trace extraction method, the extracting of the trace based on the sum of the strengths may include extracting the trace in a direction in which the sum of the strengths is highest, of the first representative directions.

In the trace extraction method, the extracting of the trace based on the sum of the strengths may include, if the sum of the strengths of signal data existing in at least two of first representative directions is highest, extracting the trace in the first one of the at least two directions.

The trace extraction method may further include: determining a second point where the strengths of all of the signal data existing in the first representative directions become zero; and extracting the trace on the left upper side of the second point while decreasing the frequency.

In the trace extraction method, the extracting of the trace on the left right side may include: choosing a plurality of second representative directions on the left upper side; calculating the sum of the strengths of n signal data closest to the second point among the signal data existing in the second representative directions; and extracting the trace based on the sum of the strengths.

In the trace extraction method, the extracting of the trace may include: if the sum of the strengths is highest in one of the second representative directions, extracting the trace in the direction in which the sum of the strengths is highest; and if the sum of the strengths is highest in at least two of the second representative directions, extracting the trace in the 135-degree direction.

In the trace extraction method, the extracting of the trace on the left side may include: choosing a plurality of third representative directions on the left side; calculating the sum of the strengths of n signal data closest to the first point among the signal data existing in the third representative directions; and extracting the trace based on the sum of the strengths.

In the trace extraction method, the extracting of the trace may include: if the sum of the strengths is highest in one of the third representative directions, extracting the trace in the direction in which the sum of the strengths is highest; and if the sum of the strengths is highest in at least two of the third representative directions, extracting the trace in the 225-degree direction.

Another embodiment of the present invention provides an apparatus for extracting an ionospheric trace. The trace extraction apparatus includes: a data selector that searches for a signal data having maximum strength among signal data displayed on an ionogram of the ionosphere and selects a point where the signal data having maximum strength is placed as a first point; and a trace extractor that extracts a trace on the right side of the first point while increasing frequency of the signal data and extracts the trace on the left side of the first point while decreasing the frequency.

In the trace extraction apparatus, the trace extractor may choose a plurality of first representative directions on the right side, calculate a sum of strengths of n signal data closest to the first point among the signal data existing in the first representative directions, and extract the trace based on the sum of the strengths.

In the trace extraction apparatus, the trace extractor may extract the trace in a direction in which the sum of the strengths is highest, of the first representative directions.

In the trace extraction apparatus, if the sum of the strengths of signal data existing in at least two of the first representative directions is highest, the trace extractor may extract the trace in the first one of the at least two directions.

In the trace extraction apparatus, the trace extractor may determine a second point where the strengths of all of the signal data existing in the first representative directions become zero, and extract the trace on the left upper side of the second point while decreasing the frequency.

In the trace extraction apparatus, the trace extractor may choose a plurality of second representative directions on the left upper side, calculate the sum of the strengths of n signal data closest to the second point among the signal data existing in the second representative directions, and extract the trace based on the sum of the strengths.

In the trace extraction apparatus, if the sum of the strengths is highest in one of the second representative directions, the trace extractor may extract the trace in the direction in which the sum of the strengths is highest, and if the sum of the strengths is highest in at least two of the second representative directions, it may extract the trace in the 135-degree direction.

In the trace extraction apparatus, the trace extractor may choose a plurality of third representative directions on the left side, calculate the sum of the strengths of n signal data closest to the first point among the signal data existing in the third representative directions, and extract the trace based on the sum of the strengths.

In the trace extraction apparatus, if the sum of the strengths is highest in one of the third representative directions, the trace extractor may extract the trace in the direction in which the sum of the strengths is highest, and if the sum of the strengths is highest in at least two of the third representative directions, may extract the trace in the 225-degree direction.

According to an exemplary embodiment of the present invention, it is possible to extract the trace of the reflecting plane of the ionosphere if the altitude of the ionosphere changes abruptly as a point of discontinuity occurs at the ionosphere at a particular frequency or if the ionosphere is formed discontinuously because there is no reflection signal. The trace extraction apparatus according to the exemplary embodiment of the present invention is able to precisely observe the ionosphere as it is readily applicable to an installed ionosphere observation system because of its compatibility with the ionosphere observation system.

### BRIEF DESCRIPTION OF THE DRAWINGS

FIG. 1 is a view showing an ionosphere observation system according to an exemplary embodiment of the present invention.

FIG. 2 illustrates an ionogram observed by the ionosphere observation system according to the exemplary embodiment of the present invention.

FIG. 3 illustrates the ionospheric trace extracted from the ionogram of FIG. 2.

FIG. 4 is a view showing a trace extraction apparatus according to an exemplary embodiment of the present invention.

FIG. 5 is a flowchart showing a trace extraction apparatus according to an exemplary embodiment of the present invention.

FIG. 6 is a view showing the concept of a vector tracking algorithm according to an exemplary embodiment of the present invention.

FIG. 7 is a flowchart showing a right-side trace extraction step according to an exemplary embodiment of the present invention.

FIG. 8 is a view showing the sum of the strengths of signals on the right side according to the exemplary embodiment of the present invention.

FIG. 9 is a flowchart showing an upper-side trace extraction step according to an exemplary embodiment of the present invention.

FIG. 10 is a view showing the sum of the strengths of signals on the upper side according to the exemplary embodiment of the present invention.

FIG. 11 is a flowchart showing a left-side trace extraction step according to an exemplary embodiment of the present invention.

FIG. 12 is a view showing the sum of the strengths of signals on the left side according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, a term such as a “unit”, an “er/or”, a “module”, a “block” or like, when used in the specification, represents a unit that processes at least one function or operation, and the unit or the like may be implemented by hardware or software or a combination of hardware and software.

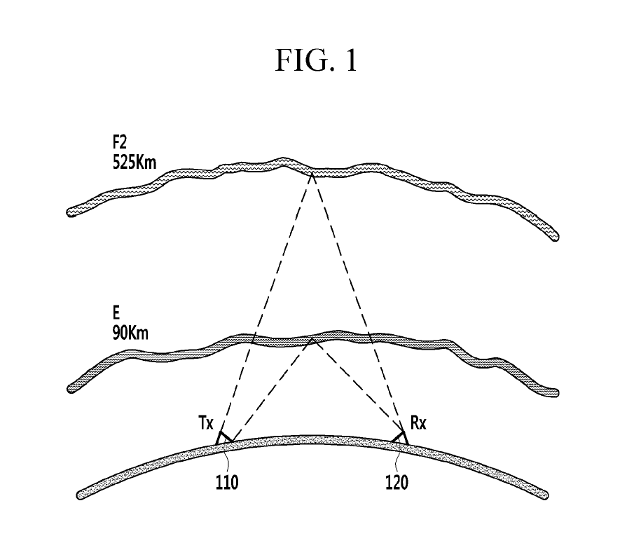

FIG. 1 is a view showing an ionosphere observation system according to an exemplary embodiment of the present invention.

Referring to FIG. 1, a radar signal for ionosphere observation is sent toward the sky from a ground transmission station (TX) 110, reflected from the ionosphere (E layer and F2 layer), and received by a ground reception station (RX) 120. Accordingly, the received radar signal (i.e., ionosphere observation signal) contains information on the ionosphere located in the sky at the midpoint of the transmission station 110 and the reception station 120. In this case, the radar signal is an HF-band pulse radar signal, which sweeps through a predetermined frequency range when it is sent. The reception station 120 can receive the ionosphere observation signal reflected from the ionosphere and obtain the altitude of the ionosphere reflecting plane at each frequency. Information on the ionosphere observed by the reception station 120 can be displayed on a graph called an ionogram. On the ionogram, the x-axis represents the frequency (unit: MHz) of a radar signal used for ionosphere observation, and the y-axis represents the altitude (unit: km) of the ionosphere.

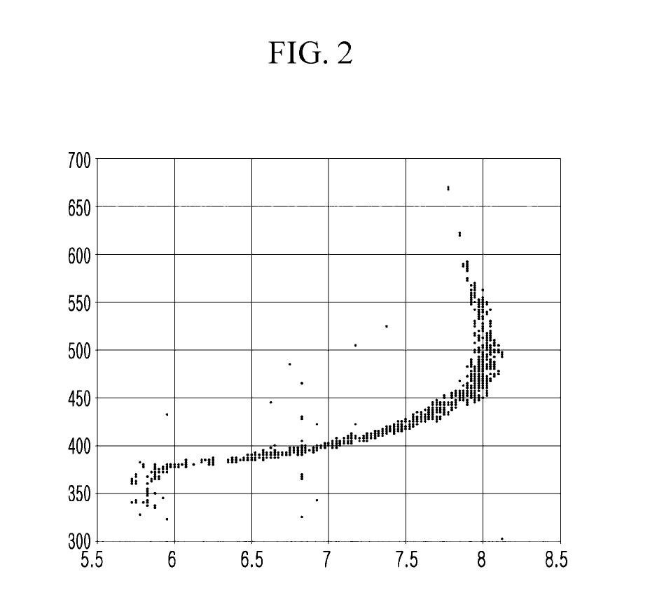

FIG. 2 illustrates an ionogram observed by the ionosphere observation system according to the exemplary embodiment of the present invention.

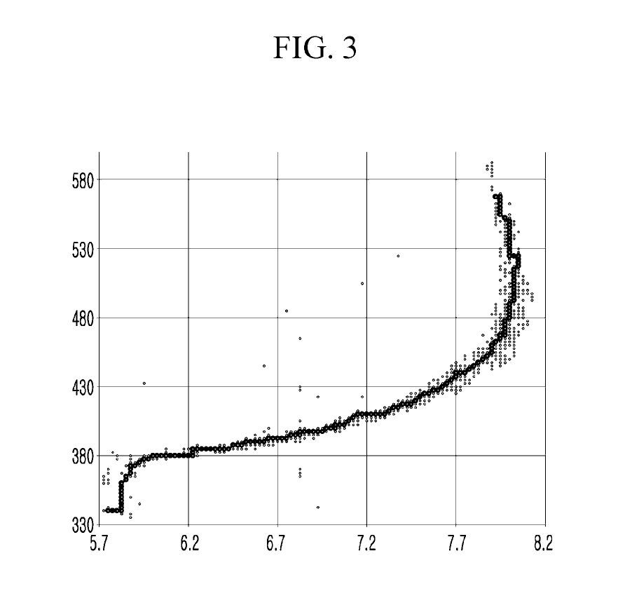

Referring to FIG. 2, in the ionosphere observation system, an ionogram is created based on a radar signal reflected from the ionosphere. Thus, a number of reflected signals at a single frequency are all displayed in the form of distributed data on the graph. Accordingly, it is necessary to extract the trace from the distributed data of FIG. 2 in order to obtain the altitude of the ionosphere at a frequency. FIG. 3 illustrates the ionospheric trace extracted from the ionogram of FIG. 2.

A method of extracting a trace from an ionogram displayed in the form of distributed data by a vector tracking algorithm will be described below.

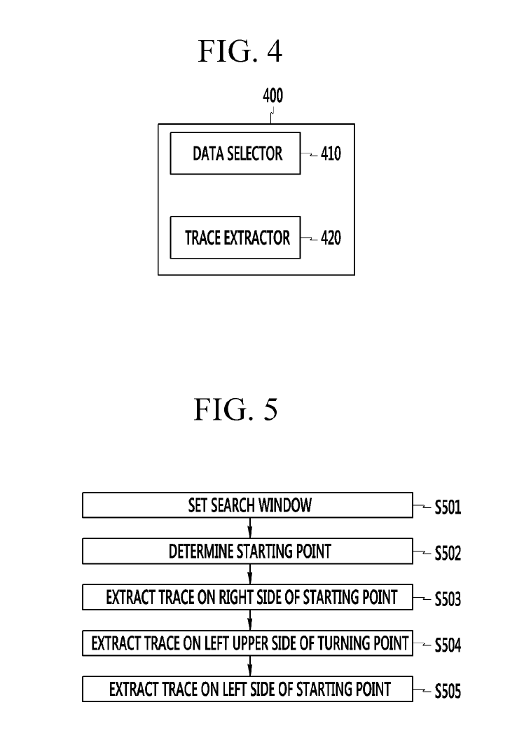

FIG. 4 is a view showing a trace extraction apparatus according to an exemplary embodiment of the present invention.

Referring to FIG. 4, the trace extraction apparatus 400 included in the ionosphere observation system includes a data selector 410 and a trace extractor 420. The trace extraction apparatus 400 according to the exemplary embodiment of the present invention may be included in the transmission station 110 or reception station 120 which sends or receives radar signals for ionosphere observation, or may be separately connected to the transmission station 110 or the reception station 120.

The data selector 410 sets the region of the ionogram where signal data is the richest as a search window, and searches for a signal data having the maximum strength in the set window. Also, the data selector 410 selects the point where the signal data having the maximum strength is placed as a starting point.

The trace extractor 420 extracts the trace on the left and right sides of the starting point selected by the data selector 410. The function of the trace extractor 420 will be described in detail below.

FIG. 5 is a flowchart showing a trace extraction apparatus according to an exemplary embodiment of the present invention.

Referring to FIG. 5, first of all, the region of the ionogram where signal data is the richest is specified (search window setting step) (S501). In the window setting step, the frequency range and the altitude range of the ionosphere are set.

Next, the data selector 410 searches for a signal data having the maximum strength in the set window (S502). In this case, the point where the signal having the maximum strength is placed becomes the starting point of trace extraction.

Next, the trace extractor 420 extracts the trace on the right side of the starting point while increasing the frequency from the starting point (S503). This step is referred to as a “right-side trace extraction step”.

If the trace is not extracted anymore even when increasing the frequency (if the trace is extracted all the way to the far right of the ionogram), the trace extractor 420 selects an unextracted point as a turning point, and extracts the trace on the left upper side of the turning point (S504). This step is referred to as an “upper-side trace extraction step”. That is, in this step, the trace extractor 420 extracts the trace while decreasing the frequency, by which the trace can be extracted even in the region of the ionogram where the altitude of the ionosphere is highest.

Thereafter, if the trace is no longer extracted even when decreasing the frequency (if the trace is extracted all the way to the top of the ionogram), the trace extractor 420 extracts the trace on the left side of the starting point (S505). This step is referred to as a “left-side trace extraction step”. Finally, when the extraction of the trace on the left side of the starting point is completed, the extraction of the entire trace is completed.

When extracting the trace in the steps S503 to S505 of FIG. 5, the trace extractor 420 uses a vector tracking method. Vector tracking is a method of estimating the trend of a trace by the algorithm to be described below and extracting the trace while moving the coordinates according to the estimated trend. The vector tracking algorithm of the present invention will be described below.

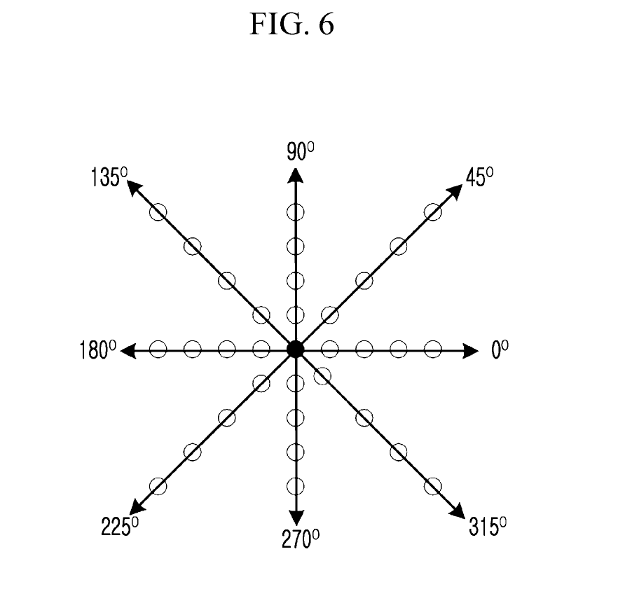

FIG. 6 is a view showing the concept of a vector tracking algorithm according to an exemplary embodiment of the present invention.

According to the vector tracking algorithm of the present invention, the trace extractor 420 extracts a trace by using one point of the ionogram as a reference point (starting point of each step of trace extraction) and comparing the strength of signals placed around the starting point. That is, the trace extractor 420 chooses n representative directions extending from the starting point of the ionogram, and calculates the sum of the strengths of m signal data respectively placed in these representative directions. Thereafter, the trace extractor 420 selects the direction in which the sum of the strengths of m signal data is highest from among n representative directions, and extracts the trace in the selected representative direction.

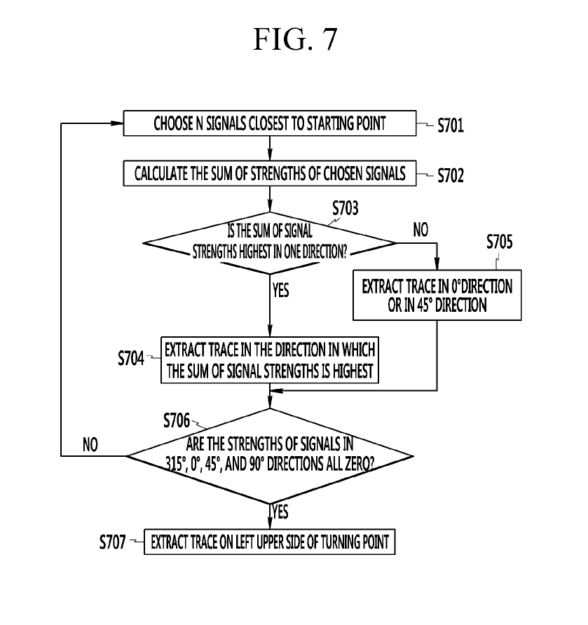

In the exemplary embodiment of the present invention, eight representative directions are chosen, and the trace is extracted based on the strength of four of the signals respectively placed in the representative directions. That is, referring to FIG. 6, the strengths of four signals in the respective directions, among the signals placed at 0 degrees, 45 degrees, 90 degrees, 135 degrees, 180 degrees, 225 degrees, 270 degrees, and 315 degrees with respect to the reference point, are added up, and the trace is extracted in the representative direction in which the sum of the strengths is highest. A method for the trace extractor 420 to extract a trace will be described in detail below with reference to FIG. 7 to FIG. 12.

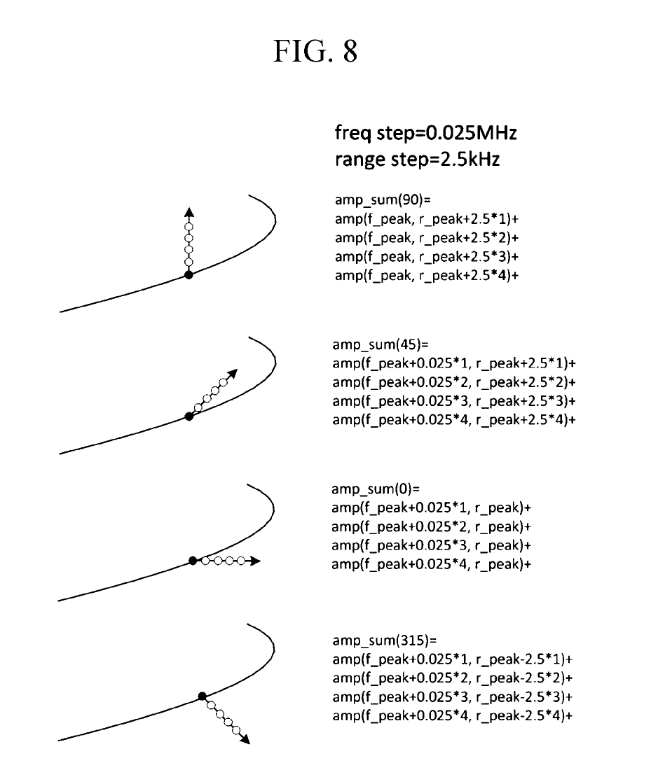

FIG. 7 is a flowchart showing a right-side trace extraction step according to an exemplary embodiment of the present invention, and FIG. 8 is a view showing the sum of the strengths of signals on the right side according to the exemplary embodiment of the present invention.

Referring to FIG. 7 and FIG. 8, when the trace extractor 420 extracts the trace on the right side of the starting point, only the vector on the right side is taken into consideration. Therefore, only the 315-degree, 0-degree, 45-degree, and 90-degree directions, out of the eight representative directions, are taken into consideration.

That is, four signals closest to the starting point are chosen from among the signals placed in each of the 315-degree, 0-degree, 45-degree, and 90-degree directions (S701), and the sum of the strengths of the chosen signals is calculated (S702).

Thereafter, the trace extractor 420 determines the direction of trace extraction by comparing the sum of strengths in each direction (S703). In principle, the trace is extracted in the direction in which the sum of strengths is highest (S704). That is, the signal data where the sum of strengths is highest is extracted as the trace, and the starting point is shifted to the extracted trace.

However, if the sum of strengths is the same for all of the four directions, the trace is extracted in the 0-degree direction. Otherwise, if the sum of strengths is highest in two or three of the 0-degree, 45-degree, and 90-degree directions, the trace is extracted in the 45-degree direction. Finally, if the sum of strengths is highest in the 315-degree direction, the trace is extracted in the 0-degree direction (S705).

Then, the trace extractor 420 continues to extract the trace until the strengths of signals existing in the 315-degree, 0-degree, 45-degree, and 90-degree directions become zero (S706). Thereafter, when the strengths of signals existing in the 315-degree, 0-degree, 45-degree, and 90-degree directions become zero, the trace extractor 420 selects the last extracted trace as the turning point, and extracts the trace on the left upper side of the turning point (S707).

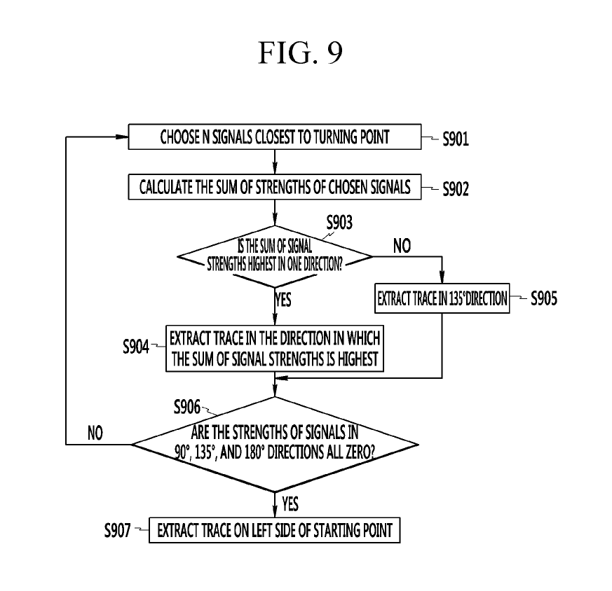

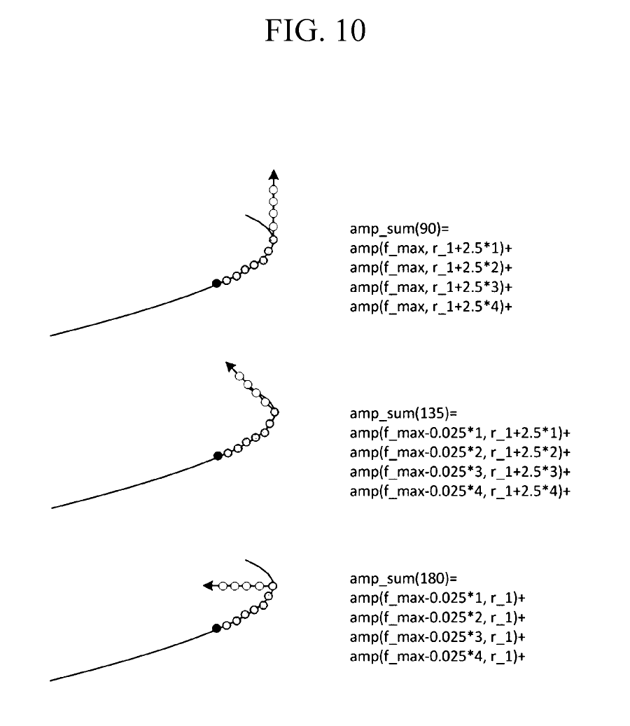

FIG. 9 is a flowchart showing an upper-side trace extraction step according to an exemplary embodiment of the present invention, and FIG. 10 is a view showing the sum of the strengths of signals on the upper side according to the exemplary embodiment of the present invention.

Referring to FIG. 9 and FIG. 10, when the trace extractor 420 extracts the trace on the left upper side of the turning point, only the vector on the left upper side is taken into consideration. Therefore, the trace extractor 420 takes only the 90-degree, 135-degree, and 180-degree directions, out of the eight representative directions, into consideration. In this case, the trace extractor 420 chooses four signals closest to the turning point from among the signals placed in each of the 90-degree, 135-degree, and 180-degree directions (S901), and the sum of the strengths of the chosen signals is calculated (S902).

Thereafter, the trace extractor 420 compares the sum of strengths for each direction, and extracts the trace in the direction in which the sum of strengths is highest (S903 and S904). If the sum of strengths is highest in two or three of the 90-degree, 135-degree, and 180-degree directions, the trace is extracted in the 135-degree direction (S905). Then, the trace extractor 420 continues to extract the trace until the strengths of signals existing in the 90-degree, 135-degree, and 180-degree directions become zero (S906).

Thereafter, when the strengths of signals existing in the 90-degree, 135-degree, and 180-degree directions become zero, the trace extractor 420 extracts the trace on the left side of the starting point (S907).

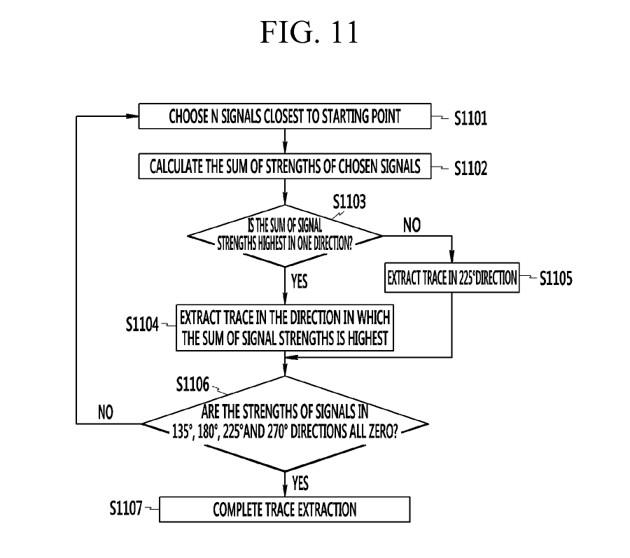

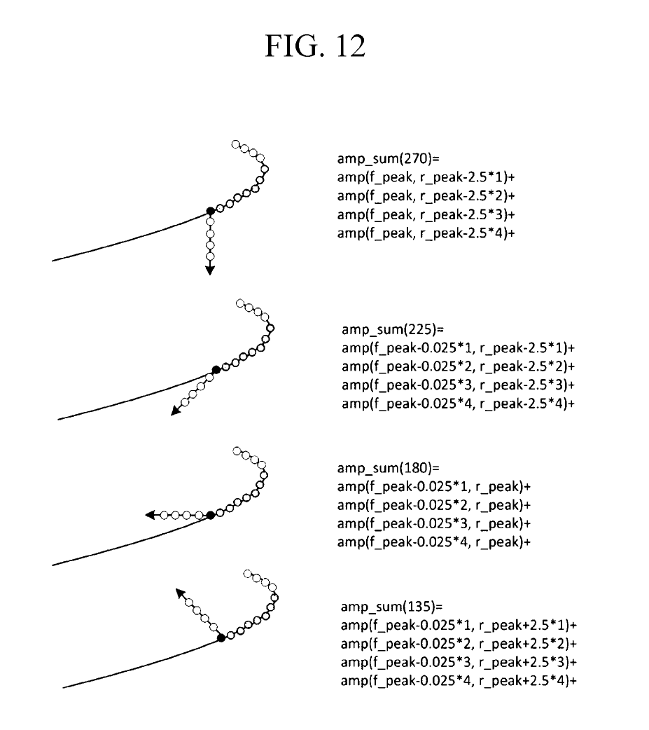

FIG. 11 is a flowchart showing a left-side trace extraction step according to an exemplary embodiment of the present invention, and FIG. 12 is a view showing the sum of the strengths of signals on the left side according to the exemplary embodiment of the present invention.

Referring to FIG. 11 and FIG. 12, when the trace extractor 420 extracts the trace on the left side of the starting point, only the vector on the left side is taken into consideration. Therefore, the trace extractor 420 takes only the 135-degree, 180-degree, 225-degree, and 270-degree directions, out of the eight representative directions, into consideration. In this case, the trace extractor 420 chooses four signals closest to the starting point from among the signals placed in each of the 135-degree, 180-degree, 225-degree, and 270-degree directions (S1101), and the sum of the strengths of the chosen signals is calculated (S1102).

Thereafter, the trace extractor 420 compares the sum of strengths in each direction, and extracts the trace in the direction in which the sum of strengths is highest (S1103 and S1104). If the sum of strengths is highest in two or more of the 135-degree, 180-degree, 225-degree, and 270-degree directions, the trace is extracted in the 225-degree direction (S1105). Then, the trace extractor 420 continues to extract the trace until the strengths of signals existing in the 135-degree, 180-degree, 225-degree, and 270-degree directions become zero (S1106).

Thereafter, when the strengths of signals existing in the 135-degree, 180-degree, 225-degree, and 270-degree directions become zero, the trace extractor 420 extracts the trace on the left side of the starting point (S1107).

According to an exemplary embodiment of the present invention, it is possible to extract the trace of the reflecting plane of the ionosphere if the altitude of the ionosphere changes abruptly as a point of discontinuity occurs at the ionosphere at a particular frequency or if the ionosphere is formed discontinuously because there is no reflection signal.

Moreover, the trace extraction apparatus according to the exemplary embodiment of the present invention is able to precisely observe the ionosphere as it is readily applicable to an installed ionosphere observation system because of its compatibility with the ionosphere observation system.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for extracting an ionospheric trace, the method comprising:
searching for a signal data having maximum strength among signal data displayed on an ionogram of the ionosphere;
selecting a point where the signal data having maximum strength is placed as a first point;
extracting a trace on the right side of the first point while increasing frequency of the signal data; and
extracting the trace on the left side of the first point while decreasing the frequency.

2. The method of claim 1, wherein
the extracting of the trace on the right side comprises:
choosing a plurality of first representative directions on the right side;
calculating a sum of strengths of n signal data closest to the first point among the signal data existing in the first representative directions; and
extracting the trace based on the sum of the strengths.

3. The method of claim 2, wherein the extracting of the trace based on the sum of the strengths comprises extracting the trace in a direction in which the sum of the strengths is highest, of the first representative directions.

4. The method of claim 2, wherein the extracting of the trace based on the sum of the strengths comprises, if the sum of the strengths of signal data existing in at least two of the first representative directions is highest, extracting the trace in the first one of the at least two directions.

5. The method of claim 2, further comprising:
determining a second point where the strengths of all of the signal data existing in the first representative directions become zero; and
extracting the trace on the left upper side of the second point while decreasing the frequency.

6. The method of claim 5, wherein
the extracting of the trace on the left right side comprises:
choosing a plurality of second representative directions on the left upper side;
calculating the sum of the strengths of n signal data closest to the second point among the signal data existing in the second representative directions; and
extracting the trace based on the sum of the strengths.

7. The method of claim 6, wherein
the extracting of the trace comprises:
if the sum of the strengths is highest in one of the second representative directions, extracting the trace in the direction in which the sum of the strengths is highest; and
if the sum of the strengths is highest in at least two of the second representative directions, extracting the trace in the 135-degree direction.

8. The method of claim 1, wherein
the extracting of the trace on the left side comprises:
choosing a plurality of third representative directions on the left side;
calculating the sum of the strengths of n signal data closest to the first point among the signal data existing in the third representative directions; and
extracting the trace based on the sum of the strengths.

9. The method of claim 8, wherein
the extracting of the trace comprises:
if the sum of the strengths is highest in one of the third representative directions, extracting the trace in the direction in which the sum of the strengths is highest; and
if the sum of the strengths is highest in at least two of the third representative directions, extracting the trace in the 225-degree direction.

10. An apparatus for extracting an ionospheric trace, the apparatus comprising:
a data selector that searches for a signal data having maximum strength among signal data displayed on an ionogram of the ionosphere and selects a point where the signal data having maximum strength is placed as a first point; and
a trace extractor that extracts a trace on the right side of the first point while increasing frequency of the signal data and extracts the trace on the left side of the first point while decreasing the frequency.

11. The apparatus of claim 10, wherein the trace extractor chooses a plurality of first representative directions on the right side, calculates a sum of strengths of n signal data closest to the first point among the signal data existing in the first representative directions, and extracts the trace based on the sum of the strengths.

12. The apparatus of claim 11, wherein the trace extractor extracts the trace in a direction in which the sum of the strengths is highest, of the first representative directions.

13. The apparatus of claim 11, wherein, if the sum of the strengths existing in at least two of the first representative directions is highest, the trace extractor extracts the trace in the first one of the at least two directions.

14. The apparatus of claim 11, wherein the trace extractor determines a second point where the strengths of all of the signal data existing in the first representative directions become zero, and extracts the trace on the left upper side of the second point while decreasing the frequency.

15. The apparatus of claim 14, wherein the trace extractor chooses a plurality of second representative directions on the left upper side, calculates the sum of the strengths of n signal data closest to the second point among the signal data existing in the second representative directions, and extracts the trace based on the sum of the strengths.

16. The apparatus of claim 15, wherein, if the sum of the strengths is highest in one of the second representative directions, the trace extractor extracts the trace in the direction in which the sum of the strengths is highest, and if the sum of the strengths is highest in at least two of the second representative directions, it extracts the trace in the 135-degree direction.

17. The apparatus of claim 10, wherein the trace extractor chooses a plurality of third representative directions on the left side, calculates the sum of the strengths of n signal data closest to the first point among the signal data existing in the third representative directions, and extracts the trace based on the sum of the strengths.

18. The apparatus of claim 17, wherein, if the sum of the strengths is highest in one of the third representative directions, the trace extractor extracts the trace in the direction in which the sum of the strengths is highest, and if the sum of the strengths is highest in at least two of the third representative directions, it extracts the trace in the 225-degree direction.
